(19) United States
(12) Patent Application Publication
(10) Pub. No.: US 2013/0098467 A1
(43) Pub. Date: Apr. 25, 2013

(54) METHOD FOR IMPROVING THE FLOW CONDITIONS IN PIPES THAT HAVE BEEN USED FOR TRANSPORTING HEAVY OR EXTRA-HEAVY CRUDES OR CRUDES WITH HIGH ASPHALTENE CONTENT

(71) Applicant: Intevep, S.A., Caracas (VE)

(72) Inventors: Pablo Manrique, Caracas (VE); Lorena Perez, Caracas (VE); Franklin Archer, Caracas (VE); Wilmer Chavarro, Los Teques (VE)

(73) Assignee: Intevep, S.A., Caracas (VE)

(21) Appl. No.: 13/655,776

(22) Filed: Oct. 19, 2012

Related U.S. Application Data
(63) Continuation-in-part of application No. 12/973,022, filed on Dec. 20, 2010.
(60) Provisional application No. 61/549,406, filed on Oct. 20, 2011.

(51) Int. Cl. F17D 1/08

(52) U.S. Cl. CPC F17D 1/08
USPC 137/13; 137/561 R

(57) ABSTRACT

A method for altering flow conditions in a pipe includes the steps of preparing a mixture of a surfactant, a co-surfactant and a carrier fluid; transporting the mixture to a pipe having inner flow surfaces and hydrocarbons adhered to the inner flow surfaces; and holding the mixture in the pipe for a period of time sufficient to form a water film over the inner flow surfaces and over the hydrocarbons adhered to the inner flow surfaces.

### CROSS REFERENCE TO RELATED APPLICATIONS

This application is a continuation-in-part of U.S. patent application Ser. No. 12/973,022 which was filed on Dec. 20, 2010. This application also claims the benefit of provisional application 61/549,534 which was filed on Oct. 20, 2011.

### BACKGROUND OF THE INVENTION

The invention relates to a formulation and method of using same for improving flow conditions in certain pipes or pipelines.

Improvement in productivity of heavy and extra heavy oil wells such as those found in the Orinoco River Belt in Venezuela is clearly desirable. Some of the largest reservoirs of heavy and extra heavy oil in the world are in Venezuela and hold oil having API gravity within the range of 6 to 16. Unfortunately, the production rate of much of this oil is unacceptable. Further, transportation of this oil can be problematic.

It is a high concern in the exploitation of heavy and extra heavy oil reservoirs to increase productivity during the well lifetime. With these wells, primary cold production schemes are quickly abandoned in favor of thermal methods to improve well flowability by reducing oil viscosity in the reservoir. These processes are costly and also still produce a low output in terms of final recovery. They also have serious problems of sour gases production such as H₂S and CO₂ which are very costly to address. Such thermal recovery methods typically produce final oil recovery below 35-40%.

Venezuelan heavy and extra heavy Orinoco River Belt oil sandstones are exceptional reservoirs. 60% of the reservoirs of this type have a KH/U value between 40 and close to 1,000 in very many cases. Unlike other reservoirs, however, the oil in Venezuelan extra heavy oil reservoirs is flowable at reservoir conditions.

Even these wells, however, have a final recovery by cold production which is very low and perhaps in most cases below three (3) percent of the original oil in place. The conditions for flow of oil in those reservoirs, with even excellent petrophysical properties, are very unfavorable to the flow of oil. The components of the heavy and extra heavy oil, particularly the asphaltenes in natural form in the native oil, are capable by natural fluid-rock interactions of generating an oil-wet condition at the surface of the natural mineral components of the sandstone. This produces the most adverse conditions to flow of oil in a porous media. This is a natural oil-wet condition of the reservoir media, which is a completely different condition as compared to formation damage in the well resulting from drilling or production activities, which could also happen in the well.

For transportation of this oil, pipelines which have been used for transporting heavy or extra-heavy crudes, particularly those with high asphaltene content can have problems with asphaltenes being deposited on the inner flow surfaces of the pipe, and this can significantly interfere with efficient flow of hydrocarbons through such pipes.

The need exists for improvement in flow rates through such pipes, particularly those which have asphaltenes and other hydrocarbons deposited on inner flow surfaces, which lead to oil wet flow environments.

### SUMMARY OF THE INVENTION

As a response to the above problems, especially to the oil-wet conditions which can occur in pipelines used to carry heavy and extra heavy crude oils and/or hydrocarbons having greater than about 1% wt asphaltenes, the present invention provides a fluid formulation and a method of using the formulation for improving flow conditions through such pipes. The result is reflected by a better flow rate in the pipe and a lower pressure drop through same.

In accordance with the invention, a method is therefore provided for altering flow conditions in a pipe, which method comprises the steps of; preparing a mixture of a surfactant, a co-surfactant and a carrier fluid; transporting the mixture to a pipe having inner flow surfaces and hydrocarbons adhered to the inner flow surfaces; and holding the mixture in the pipe for a period of time sufficient to form a water film over the inner flow surfaces and over the hydrocarbons adhered to the inner flow surfaces.

### BRIEF DESCRIPTION OF THE DRAWINGS

A detailed description of preferred embodiments of the present invention follows, with reference to the accompanying drawings, wherein:

FIG. 1 schematically illustrates a treated surface in accordance with the invention;

FIG. 2 illustrates typical and preferred flow rates from the hydrocarbon producing well;

FIGS. 3 and 4 illustrate a test glass plate which is oil-wet in FIG. 3, and which has been treated in accordance with the present invention in FIG. 4;

FIG. 5 shows the test plate is still oil-wet even after solvent cleaning;

FIG. 6 illustrates results of use of the present invention in the form of pressure drop in a porous media before and after several treatments in accordance with the present invention;

FIG. 7 further illustrates pressure drop in a test system following initial and subsequent treatments in accordance with the present invention;

FIG. 8 illustrates return permeability test results for each cycle from Example 4;

FIGS. 9 and 10 illustrate behavior of Ko and Kw vs water saturation, and ratio, for two testing fluids from Example 4.

### DETAILED DESCRIPTION

The invention relates to a formulation or stimulation fluid which has a surfactant/co-surfactant mixture and a method for using same to treat pipes or pipelines with oil wet inner flow surfaces and thereby enhance flow of hydrocarbons through same. This method is advantageously used to alter flow conditions in the pipe.

As mentioned above, many significant hydrocarbon deposits in the world contain very large quantities of hydrocarbons under conditions where it is very difficult to produce them. One example of this is asphaltene-bearing hydrocarbon deposits in the Orinoco River Belt of Venezuela. In these formations, which typically have high and low pressures in the range of 300-1,500 psi, the heavy hydrocarbon fractions contained in the formation, especially asphaltenes, tend to adhere to the pore surfaces of the hydrocarbon and thereby create an oil-wet environment in the reservoir. As detailed above, this oil-wet flow environment is not at all conducive to production of those hydrocarbons from the formation. Further, as will be demonstrated below, this asphaltene is not easily removed because a portion of the hydrocarbon adsorbs into the rock surface making even cleaned surfaces oil wet and, therefore, unfavorable for good hydrocarbon flow.

Transport of heavy and extra-heavy crude oils produced from such formations can create similar problems in the pipes or pipelines through which the hydrocarbons are transported. Specifically, hydrocarbons such as asphaltenes and the like deposit upon the inner flow surfaces of the pipe or pipelines and this creates an oil wet condition, as well as a partial obstruction to the flow of the pipe or pipeline. The mixture of surfactant and co-surfactant, as discussed herein, can advantageously be used to treat the hydrocarbon-bearing formations from which the hydrocarbons are produced, and also the pipes and pipelines through which the hydrocarbon is transported. As discussed herein, a surfactant and co-surfactant mixture can be used to treat the inner flow surfaces of the pipe and pipelines in accordance with the present invention.

In accordance with the present invention, the surfactant/co-surfactant mixture is used to form a water film over asphaltenes and other substances deposited on inner flow surfaces of the pipe or pipelines to be treated so as to provide a water-wet surface between the flow surfaces, and the hydrocarbon which is to be passed through the pipe or pipeline. This water film increases flow of hydrocarbons, and thereby enhances transportation efficiency of hydrocarbon. Over a period of time, the water film eventually is removed by fluids flowing past the film, at which point the surfactant/co-surfactant mixture of the present invention can again be introduced into the pipe or pipeline to again deposit a fresh water film for use in the next period of hydrocarbon transportation.

According to the invention, the surfactant/co-surfactant mixture preferably contains surfactant, co-surfactant and a fluid carrier, each of which has the following preferred constituents.

The surfactant is preferably selected from the group consisting of anionic surfactants, cationic surfactants, non-ionic surfactants, amphoteric surfactants and combinations thereof. The surfactant is further preferably an ethoxylated fatty alcohol having between 4 and 80 ethoxylate groups.

Suitable non-ionic surfactants include but are not limited to octilphenol having 9-16 EO, nonylphenol ethoxylate with an EO number from 4 to 80, preferably 4 to 60 and more preferably 25-35, fatty acids of 9-20 EO, n-tetradecanol of 9-20 EO, n-hexadecanol of 9-20 EO, laurate of sorbitan, and polyethoxilated fatty alcohols with EO number from 4 to 80, preferably 4 to 60 and more preferably 20-35. Suitable ionic surfactants include but are not limited to n-alkyl sulfates of K or Na, n-alkyl trimethyl ammonium chloride and combinations thereof, and petroleum sulphonates.

The co-surfactant is preferably an alcohol co-surfactant, preferably one or more n-alcohols (C1-C6), and more preferably selected from the group consisting of methanol, ethanol, propanol, butanol, pentanol, isopropanol and combinations thereof. The most preferred co-surfactant is methanol and/or ethanol.

The carrier fluid can be selected from the group consisting of organic solvents, light hydrocarbons, diluents, light crude oil, light oil, light refinery cut, gasoil, diesel, water and combinations thereof. The most preferred carrier fluid is an oil fluid. One example is compatible light crude oil with API gravity between 20 and 45 API, preferably between 20 and 25 API. Also, some mixtures of compatible crude oil with the formation fluids and/or naphtha can be used for reducing viscosity of the heavy and extraheavy oil fluid flow for transportation in surface facilities.

The surfactant/co-surfactant mixture preferably is prepared having substantially equal amounts by volume of the surfactant and co-surfactant, and the overall mixture with carrier fluid preferably contains each of the surfactant and co-surfactant in an amount between 0.1 and 5% by volume, more preferably between 1 and 4% by volume.

The surfactant/co-surfactant mixture of the present invention can be used for treatment of wells and pipes or pipelines as discussed above. When used to treat pipes, a sufficient volume of the mixture is prepared, and this mixture is pumped into the pipe to be treated and held in place in this pipe for a period of time sufficient to form a film of water on the inner surface of the pipe. This can preferably be a period of time of at least about 2 hours. After such period of time, the mixture can be pumped from the pipe, and preferably recovered from the pipe for use in treating additional pipes and the like. Once the mixture is removed, the pipe or pipeline can be placed back in service for use in transporting various hydrocarbons such as heavy and extra-heavy crudes, and the water film deposited over the inner surface of the pipe and also over the adhered hydrocarbons on the inner surface of the pipe creates an improved flow condition in the pipe for carrying heavy and extra-heavy crudes.

During the normal operation of the pipe to transport such hydrocarbons, the pressure drop in the pipe can be monitored, and when a sufficient pressure drop has been reached that further treatment is warranted, the pipeline can again be treated with a mixture of surfactant/co-surfactant as discussed above in accordance with the present invention.

In accordance with the invention, the surfactant/co-surfactant mixture can be prepared by mixing the above-identified constituents at the surface and then transporting, for example by pumping, the resulting mixture or stimulation fluid into a pipe or pipeline to be treated.

Once a sufficient volume of fluid is pumped into the pipe or pipeline, this volume is then held in place for a time sufficient to form the desired water film over flow surfaces of the pipe or pipeline and also over the hydrocarbons adhered to these surfaces. This advantageously provides a water-wet flow environment which is advantageous to the flow of hydrocarbon, and therefore produces a flow environment which is far more conducive to the flow of oil than the oil-wet flow environment which may be present in the pipe or pipeline after use transporting hydrocarbons where heavy hydrocarbons, and especially asphaltenes, can become adhered to the flow surfaces. As indicated above, a suitable amount of time to hold the fluid in the pipe or pipeline will vary with different conditions but will typically be at least 2 hours and more depending upon economic factors of having the pipe or pipeline out of service.

The typical pipe or pipeline for which the present invention can be utilized can be any pipe or pipeline wherein the forming of a water film over the flow surfaces would be beneficial. A particularly desirable application of the present invention is in pipelines used to transport hydrocarbons with an API gravity of between 6 and 16, and more preferably having an API gravity of between 6 and 12. These heavy and extra heavy hydrocarbons contain asphaltenes as discussed above, and these are ideal candidates for treatment according to the present invention to enhance flow conditions.

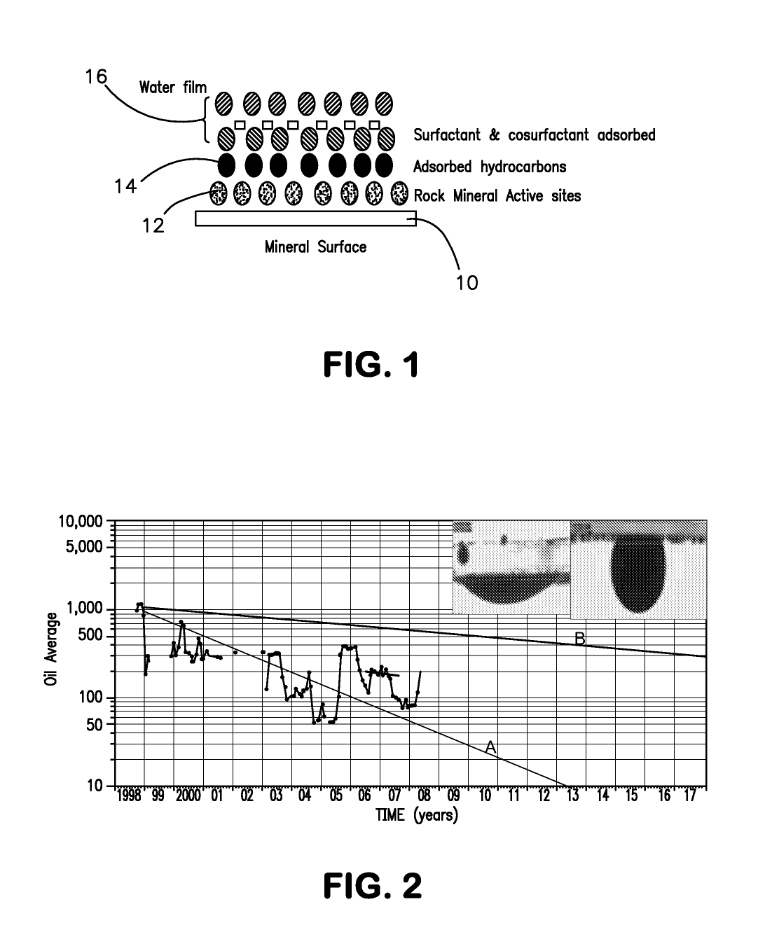

FIG. 1 schematically illustrates a surface of a hydrocarbon bearing formation which can be treated with the surfactant/co-surfactant mixture of the present invention. As seen in FIG. 1, in this environment, a mineral surface 10 which defines pore space of the formation has rock mineral active sites 12 along surface 10, and these rock mineral active sites 12 interact with hydrocarbons under the typical pressure in the formation such that chemically adsorbed hydrocarbons 14 are closely adhered to surface 10, particularly at rock mineral active sites 12.

A surfactant/co-surfactant mixture can be introduced to the formation and held there in the presence of water so that a film of water is formed over the adsorbed hydrocarbons 14 as well as the rock mineral active sites 12 of mineral surface 10. FIG. 1 shows surfactant/co-surfactant mixture adsorbed in the form of water film 16 which is schematically illustrated as a double layer to represent the surfactant/co-surfactant mixture. This produces a water-wet condition at the surface, which enhances flow of hydrocarbon through flow areas and pore space defined by such a treated surface. Similar flow conditions can occur in pipes or pipelines used to carry heavy hydrocarbons, and in such cases the adsorbed hydrocarbons 14 would be deposited on inner flow surfaces of the pipe or pipeline.

Pressure drop in a pipeline is a good measure of the flowability in the pipeline. When the pressure drop is relatively small, this indicates good flowing properties in the pipeline. While transporting fluids through a pipeline that has been treated according to the invention, it is desirable to monitor the pressure drop and after a certain amount of use of the pipeline, the pressure drop starts to increase. This increase indicates that the water film has been worn away or removed due to relatively high velocity flow of fluids passing over the film. While this stream of fluids is flowing, the water film is diminishing with time by desorption of the surfactant and co-surfactant from the flow surface and adsorbed hydrocarbon. At this stage, according to the invention, the pipe or pipeline can be treated again with the same or similar formulation, and this process can be repeated as many times as desired to maintain efficient flow in the pipe or pipeline. The present invention reduces the time and need of costly processes which might otherwise be needed in the pipe or pipeline.

FIG. 2 illustrates typical and desired oil average flow rates from a hydrocarbon production well. The starts and stops shown in actual flow show a trend (line A) which is not desirable, while a preferred, flatter pressure behavior is shown at line B. The difference of the area between lines A and line B is an indication of greater recovery of oil from same well in same well drained area. The surfactant/co-surfactant mixture of the present invention can be used to produce fluids from a well at a pressure behavior closer to line B as desired. In addition, similar fluid and oil wet conditions can occur in pipes or pipelines. The following examples deal with a hydrocarbon-bearing formation, but the principles illustrated apply equally to the pipe or pipeline environment of the present invention.

The following example further illustrates the invention and the results which are obtained using same.

### Example 1

Crude oil and water from several wells in different areas of the Orinoco River Belt fields were collected. The oil and water were placed in closed glass vessels at several oil and water saturations, at reservoir conditions of water salinity and temperature, in a thermally controlled oven. Inside each vessel was placed a small glass plate which was monitored for wettability conditions starting with a water-wet condition and further being naturally changed to oil wet after a medium time period of about three to four weeks at reservoir temperature of 145° F. For each glass plate, wettability was measured by contact angle measurement techniques at the well temperature ranging from water-wet at the initial condition to oil wet after three weeks of aging process in the vessels at reservoir conditions.

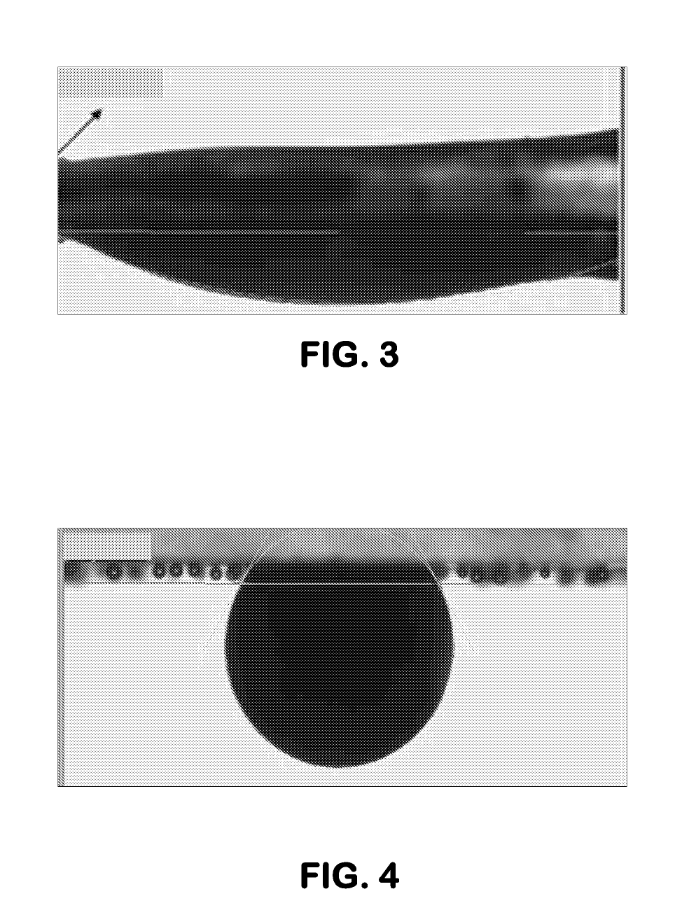

After this treatment, the glass plates had a contact angle with oil which shows a strongly oil-wet condition as can be seen in FIG. 3, which shows the oil spreading over the plate surface.

Each plate was then placed in a beaker for a soaking time with a mixture of equal amount of the well fluids in a mean average of 18% formation water and 82% extra heavy oil at 145° F. temperature, with the formulation of the present invention, which in this particular example comprised a solution of 1% volume of tridecanol with 16 ethoxylated groups and 1% volume of ethanol, both admixed with 98% diluent which was a light hydrocarbon cut used in the production area to improve the flowability of extra heavy oil at surface conditions. The mixture and the plate were held for an 8 hour exposure time at reservoir temperature of 145° F. and contact angle measurement showed wettability reversal from oil wet as shown in FIG. 3 to water wet as shown in FIG. 4. Note the bubbling up of the oil, and contact angle clearly indicative of the now water wet surface.

Similar results can be obtained by using various non-ionic and ionic surfactants as disclosed above.

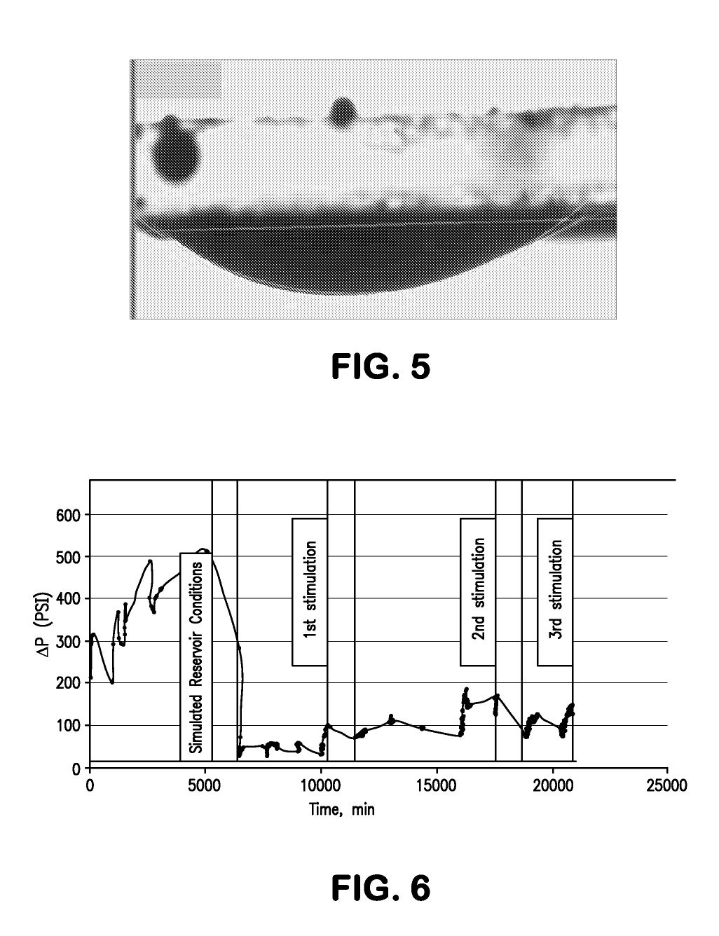

The glass plates were then soaked with a solution of mutual solvent for more than twenty four (24) hours to remove the water film and any visible hydrocarbon. The cleaned glass plates showed a clear and clean surface, but when a drop of water was placed on the plate, the water drop did not spread on the surface. The contact angle was measured and the plate still exhibited an oil-wet condition, as shown in FIG. 5.

This indicates that even though the mineral surface, such as sandstone, can be cleaned of adhered hydrocarbons still on that surface, there remains a chemically adsorbed film of hydrocarbon and therefore on such a mineral surface there exists a strong oil-wet wetability. As mentioned previously, the oil-wet wetability is the most adverse condition for the recovery of oil in a porous media. Thus, even by undertaking the cost and steps of removing the adhered asphaltenes, the resulting cleaned surface remains oil wet.

Use of the formulation and method of the present invention creates a water film on the mineral surface, covering the previously chemically adsorbed hydrocarbons. This film creates an interface that will conduct hydrocarbon flow for very long periods of time between stimulation cycles. A very low pressure drawdown is achieved with the increased oil flow rates, thereby providing great benefits to the productivity and final recovery of oil from the drained area of the well.

### Example 2

Porous media displacement equipment was set up to run a displacement test to simulate well flow conditions with and without the use of the formulation of the present invention. A Hassler cell was selected since a simulation of the formation grain pressure can be achieved with such a cell. Synthetic core material was made with commercial sand obtaining a core permeability between 6-7 Darcies. Pressure change at the inlet and outlet of the cell was monitored with sensors. Cylinders were coupled to the cell to provide, at reservoir temperature and pressure, the reservoir fluids and the stimulation fluid. After a long period of stabilization of constant flow with only reservoir fluid, the stimulation fluid of the present invention was injected from the outlet and held for a soaking period of 24 hours. After soaking, flow was restarted and the pressure drop was monitored. A measurement was taken of the porous volume displaced and time through the core as a production fluid. The oil used as reservoir fluid had the following characteristics:

### Saturated %: 9 wt

### Aromatics %: 42 wt

### Resins %: 38 wt

### Asphaltenes %: 11 wt

### Acidity: 3.02 mg KOH/g

### Viscosidad CP 12,620 at 145 F

### API: 7.6%

### % C wt 70.65%

### % H wt 11.48

Water with 13,000 ppm NaCl

The water used had 13,000 ppm of NaCl. The temperature of the oven was 145° F. The formulation of the present invention for the displacement test was a solution of 98 ml of diluent admixed with a previously mixed and homogenized mixture of 1 ml of tridecanol ethoxylated having 17 EO groups and 1 ml of ethanol.

Continuous flow was reached through the synthetic sand packed core saturated with oil to about 78% volume and a water saturation of about 22% by volume. The core was aged to reach an oil wet condition exposing it to pressure and temperature conditions of 1,150 psi and 145° F., which are typical of the Carabobo field of The Orinoco River Belt reservoirs, for about four weeks. Fluid flow was then reestablished by displacing oil until continuous flow was again reached. The stimulation system with diluent as a carrier fluid was then squeezed into the production area of the core and held at rest for a 24 hour time period. After that, oil was again allowed to flow, and an excellent lower differential pressure was observed for about three (3) pore volumes of oil produced in the collecting recipient. A second stimulation squeeze identical to the initial one was made and after 24 hours the flow was restarted, showing again improved properties to flow in two (2) porous media volumes of flow. A third cycle of stimulation was made observing the same results as the first cycle. FIG. 6 shows a graph of the measured pressure during the several cycles of production and squeeze.

The same test was run with the reservoir fluids as shown below:

### OIL:

### Saturated %: 8 wt

### Aromatics %: 44 wt

### Resins %: 35 wt

### Asphaltenes %: 13 wt

### Acidity: 3.90 mg KOH/g

### Viscosidad CP 10,420 at 145 F

### API: 12%

### % C wt 84.55%

### % H wt 11.12

Water with 2,500 ppm NaCl

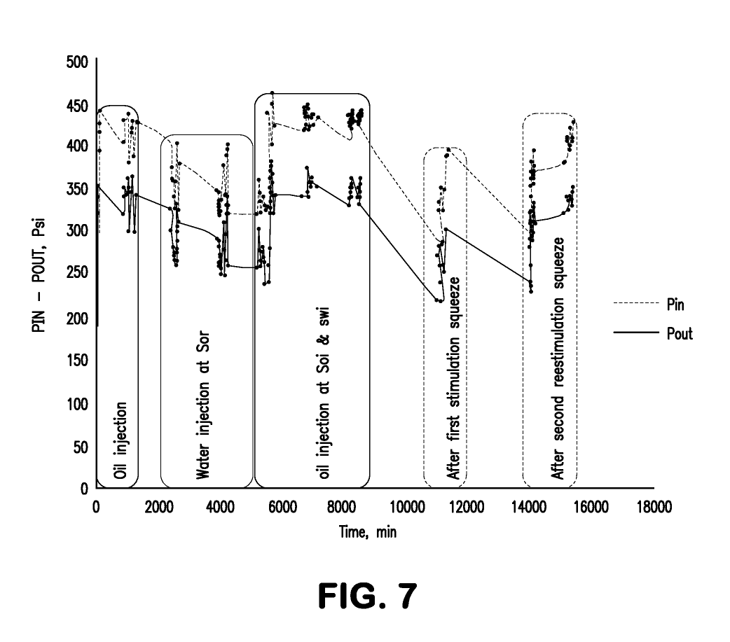

FIG. 7 shows the results in pressure behavior in the displacement system while producing an average of three porous volumes in between each stimulation injection.

### Example 3

Two highly deviated Orinoco River Belt wells from the Cerro Negro area were selected for pilot testing. Main characteristics of the wells are:

| | | | Rock properties | | | | | Original | Actual | |
|---|---|---|---|---|---|---|---|---|---|---|
| | Reservoir | Completion | Porosity | K | | Thickness | Production | pressure | pressure | |
| Well name | name | Date | % | Darcy | Vsh | ft | Method | psi | psi | Lithology |
| CD 36 | OFIM CNX9 | April 1992 | 33 | 2.3 | 5.3 | 194 | Mechanical pump & | 1100 | 1095 | sandstone |
| | | | | | | | Gravel pack | | | |
| CD 37 | OFIM CNX9 | February 1993 | 32 | 5 | 7.0 | 192 | PCP Gravel pack | 1350 | 1000 | sandstone |

An amount of 270 barrels of diluent, which is a light crude oil of 23 API gravity, was admixed with a previously homogenized mix of 1.3 barrels of tridecyl alcohol of 12 EO groups and 1.3 barrels of methanol in a tank of a pumping truck. The admixture was recirculated in the tank for homogenization and pumped to well CD 36 through the annular space between the tubing and the casing. The stimulation fluid of the present invention contacted the gravel pack downhole and passed to about two feet penetration in the formation. The well was closed for a soaking period of 24 hours. The well was restarted thereafter and showed an increased production of about 200 bpd that has been stable for a period of 60 days.

Another amount of 133 barrels of diluent, a light crude oil of 23 API gravity was admixed with a previously homogenized mix of 0.7 barrels of tridecyl alcohol of 12 EO groups and 0.7 barrels of methanol in a tank of a pumping truck. The admixture was recirculated in the tank for homogenization and pumped to well CD 37 through the annular space between the tubing and the casing. The stimulation fluid of the present invention contacted the gravel pack downhole and passed to about two inches of penetration in the formation. The well was closed for a soaking period of 24 hours. The well was restarted thereafter and showed a production of 80 barrels net of oil per day and has been stable for a period of 60 days thereafter. The net oil production before the stimulation was 24 barrels of net oil.

These pilot tests establish that the stimulation fluid, or formulation, of the present invention is highly effective at improving hydrocarbon flow and production through porous media treated with fluid. The fluid is made from readily available constituents, and the method can be carried out using known equipment already available for injecting other well stimulation fluids.

### Example 4

A laboratory test was conducted for evaluating relative permeability with extraheavy crude oil and formation water and INTESURF™ 3PW0.5 solution prepared according to the invention with production water from the Cabrutica field of the Junín Division of the Orinoco River Belt Basin in Venezuela, and using a core of well E20P15 and the formation fluids of well DE 22 13 of the same field.

The core from a depth of 2212.2 feet from Cabrutica field was taken, and two samples were packed for use in a confined cell, one sample for return permeability testing and the other sample for relative permeability testing of extraheavy oil and formation water and extraheavy oil and INTESURF 3PW0.5 solution. The samples were cleaned, restored and aged for 16 days at the reservoir temperature of 145 F and a confining pressure of 1250 psi in a confined cell. An imbibition Amott test was performed to both samples to insure an oil wet condition of the sample before the tests. The core properties for two samples are shown in Table 1.

### Table 1

COMPANY INTEVEP S.A
CORE FROM WELL E20P15 CABRUTICA FIELD VENEZUELA

| | Confining | | | | Results Ø to Helio | | | | | | |
|---|---|---|---|---|---|---|---|---|---|---|---|
| Sample | pressur [symbol] | Weigth | | | Vol. | Vol | Density | | Vol | PERMEABILYTY | |
| # | PSI | Total | Long | Diam | grain | Pore space | grain | Ø | Total | Air | Klink. |
| 1A | 1300 | 86.03 | 4,875 | 3,596 | 30.67 | 17.42 | 2,632 | 36.2 | 48.09 | 2697 | 2605 |
| 2B | 1300 | 96.42 | 5,143 | 3,702 | 34.42 | 19.22 | 2,628 | 35.8 | 53.64 | 2596 | 2507 |

[symbol]

indicates data missing or illegible when filed

INTESURF 3PW0.5 solution is a mixture of 99% V/V production water from the Cabrutica field and a 0.5 V/V of nonylphenol ethoxilated with 30 ET groups, and 0.5 V/V % methanol. 1 lb/bbl of potassium acetate is added for clay control to the final admixture.

### Return Permeability Test

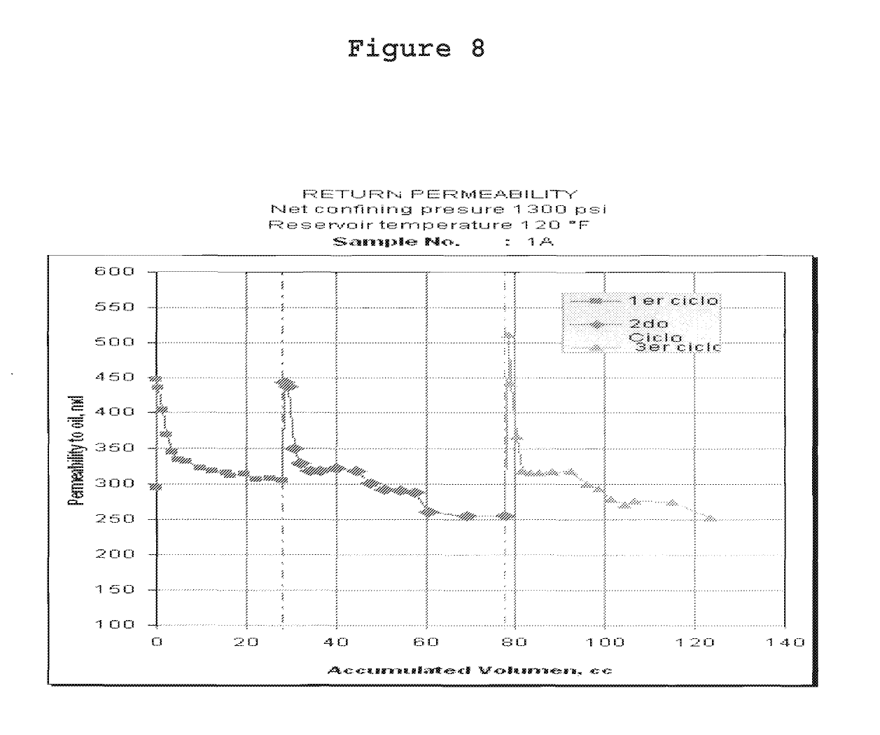

Core sample 1A with an oil wet condition confirmed by the imbibition Amott test was placed in the confined cell at 1300 psi confining pressure. Thereafter extraheavy live crude oil from well DE 22 13 of Cabrutica field was displaced until a constant pressure drop was achieved. The permeability to oil (Ko) at the initial water saturation was measured and this value was taken as the reference base relative permeability to oil in the sample. Three cycles of returned permeability test were made, and previous to each cycle, 10% of the porous volume of the sample was squeezed with the INTESURF™ 3PW0.5 solution into the production end of the core sample, and the same volume allowed to be discharged from the opposite end of the core sample. A soaking time of 24 hours was allowed to each cycle before the displacement of live crude oil was restarted. The rate of flow and the pressure drop was monitored and the permeability to oil at several points of porous volume displaced was measured. FIG. 8 exhibits the return permeability test results for each cycle and Table 2 the values from the test obtained.

TABLE 2
RETURN PERMEABILITY
Net confining presure 1300 psi
Reservoir temperature 120° F.

| | | |
|---|---|---|
| Company: INTEVEP | Sample No. | 1A |
| Well: E20-P15 | Depth | 2212.2 ft |
| Field: Cabrutica | Porosity | 0.354 fraction |
| (Intesurf Plus) | K Kklinkemberg | 2295 md |
| Stimulation fluid: INTESURF 3PW | (Ko) K to oil | 294 md |
| 0.5 | | |
| INTESURF Carrier fluid: | | |
| Production water | | |
| Squeezed stimulation | | |
| fluid: 10% porous volume | | |

| 1er | 2do | 3er | 1er | | | |
|---|---|---|---|---|---|---|
| cycle | cycle | cycle | cycle | 2do | | |
| Vol. | Vol. | Vol. | K to | cycle | 3er cyccle | Skin |
| Acum., | Acum., | Acum., | oil, | K to oil, | K to oil, | factor |
| cc | cc | cc | md | md | md | SF = 1 − K/Ko |
| 0.19 | 28.58 | 78.58 | 448 | 444 | 511 | −0.737 |
| 0.35 | 29.61 | 79.08 | 436 | 437 | 442 | −0.502 |
| 1.14 | 30.93 | 80.37 | 405 | 350 | 366 | −0.243 |
| 2.30 | 32.28 | 81.51 | 369 | 328 | 318 | −0.081 |
| 3.38 | 34.45 | 83.43 | 344 | 318 | 315 | −0.069 |
| 4.93 | 36.48 | 85.30 | 334 | 317 | 315 | −0.070 |
| 6.48 | 40.02 | 88.41 | 331 | 321 | 316 | −0.074 |
| 9.68 | 44.38 | 92.16 | 322 | 318 | 318 | −0.081 |
| 12.45 | 47.67 | 95.64 | 318 | 301 | 299 | −0.017 |
| 15.60 | 50.97 | 98.39 | 316 | 292 | 293 | 0.004 |
| 16.50 | 54.22 | 101.42 | 311 | 290 | 278 | 0.054 |
| 19.50 | 57.39 | 104.21 | 314 | 287 | 271 | 0.080 |
| 22.39 | 60.42 | 106.78 | 306 | 260 | 276 | 0.063 |
| 25.36 | 69.24 | 115.14 | 307 | 254 | 274 | 0.069 |
| 28.13 | 77.50 | 123.55 | 304 | 255 | 252 | 0.143 |

A stimulation state was found in all cycles suggesting the cyclic stimulation of the sandstone-production end zone as a productivity improvement of the well by reducing the pressure drop and increasing the production of extraheavy oil from the well. No formation damage was observed even after a large amount relative to porous volume of live extraheavy oil was displaced and desorption of the surfactants of Intesurf in the porous media occurs. After restimulation with the Intesurf solution, a better condition of relative permeability to oil is achieved. It is believed that the relative permeability to oil lost after a great volume of displacement of oil and after several cycles of squeezes is due to the new water saturation without Intesurf base surfactant increases in the porous media. However, it is observed that once the surfactant is available by restimulation in the porous media, a new improvement of the oil relative permeability is achieved and even reaches levels higher than earlier cycles.

A relative permeability test of extraheavy oil and formation water and extraheavy oil and INTESURF 3PW0.5 solution with production water was then conducted.

Core sample 2B was insured to have an oil wet condition by Amott imbibition test and thereafter was placed in a confined cell at confine pressure of 1300 psi. Temperature was that of the reservoir of 120° F. Extraheavy oil was displaced at a pressure of 1000 psi until a constant flow was achieved. The relative permeability effective to oil was measured at the initial water saturation. Thereafter, formation water was displaced at a constant rate of 1 cc/min and monitoring of the produced fluids and pressure drop was made until no flow of extraheavy oil is observed. The effective water permeability at the residual oil saturation is measured for each sample and the volume of extraheavy oil produced at room conditions is corrected to reservoir conditions using the viscosity and volumetric factor of the reservoir. The final saturation of the fluids is determined by material balance. The effective permeability of each phase is calculated using Darcy's Law. The relative permeability water-extraheavy oil and Intesurf solution-extraheavy oil ratios at non-stable state were calculated using the methods of Jones and Roszelle.

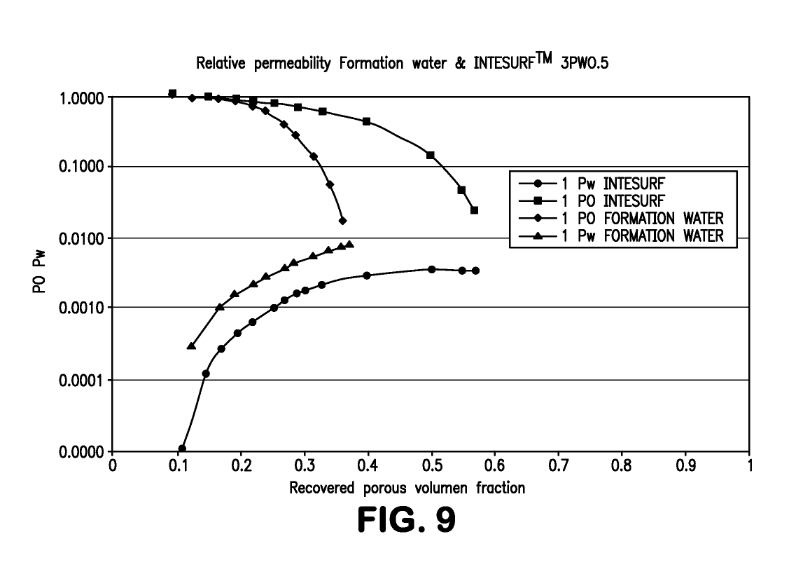

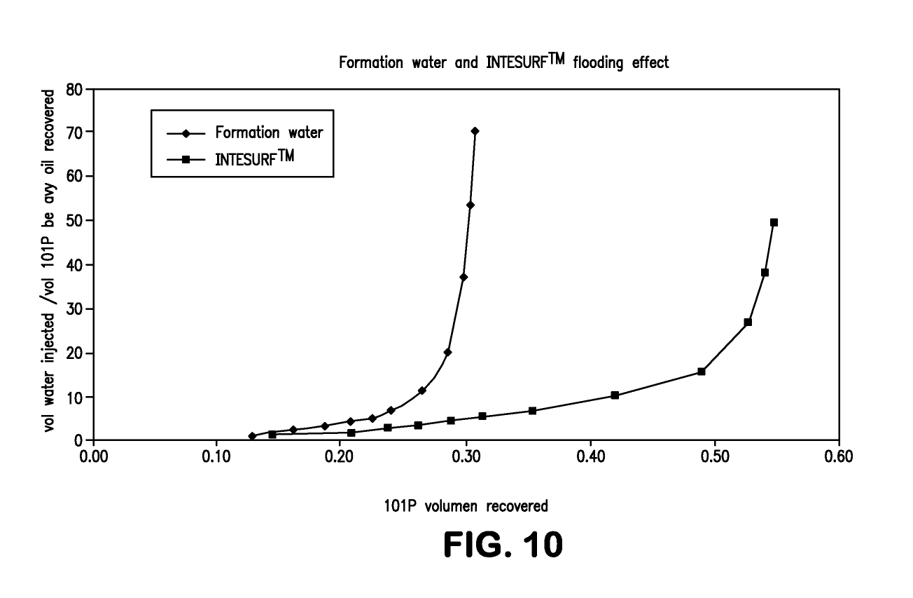

Once the formation water-extraheavy oil test was run extraheavy crude was displaced for the core sample until a condition of initial water saturation and extraheavy oil saturation was achieved. In this state the permeability effective to oil was measured and displacement with the solution of INTESURF™ 3 PW0.5 took place with a rate 0.1 cc/min for 8 hours allowing a soaking time of 12 hours and so on until only solution of INTESURF™ 3 PW0.5 was collected as the production without any extraheavy oil. The final recovery of extraheavy oil was 10.02 cc which is a 52.13% of the total porous volume and 57.89% of the original extraheavy oil in place. FIG. 9 exhibits the behavior of Ko Kw vs the water saturation for the two testing fluids and FIG. 10 exhibits the ratio.

Based upon the foregoing, a beneficial change in permeability and production levels is demonstrated by using the formulation and method of the present invention.

It is to be understood that the invention is not limited to the illustrations described and shown herein, which are deemed to be merely illustrative of the best modes of carrying out the invention, and which are susceptible of modification of form, size, arrangement of parts and details of operation. The invention rather is intended to encompass all such modifications which are within its spirit and scope as defined by the claims.

We claim:

1. A method for altering flow conditions in a pipe, comprising the steps of:
preparing a mixture of a surfactant, a co-surfactant and a carrier fluid;
transporting the mixture to a pipe having inner flow surfaces and hydrocarbons adhered to the inner flow surfaces; and
holding the mixture in the pipe for a period of time sufficient to form a water film over the inner flow surfaces and over the hydrocarbons adhered to the inner flow surfaces.

2. The method of claim 1, wherein the pipe is a pipeline for transporting hydrocarbon comprising heavy and extra-heavy crude oil.

3. The method of claim 2, wherein the hydrocarbon has an API gravity of between 6 and 16.

4. The method of claim 3, wherein the hydrocarbon has an API gravity of between 6 and 12.

5. The method of claim 1, wherein the surfactant is selected from the group consisting of anionic surfactants, cationic surfactants, nonionic surfactants, amphoteric surfactants and combinations thereof.

6. The method of claim 1, wherein the co-surfactant is an alcohol co-surfactant.

7. The method of claim 6, wherein the alcohol co-surfactant is selected from the group consisting of methanol, ethanol, propanol, butanol, pentanol, isopropanol, and combinations thereof.

8. The method of claim 1, wherein the carrier fluid is selected from the group consisting of organic solvents, light hydrocarbons, diluents, light crude oil, and combinations thereof, and water.

9. The method of claim 1, wherein the carrier fluid is a light crude oil with an API gravity between 20 to 25.

10. The method of claim 1, wherein the surfactant is an ethoxylated fatty alcohol having between 4 and 80 ethoxylated groups, and wherein the co-surfactant is methanol and/or ethanol.

11. The method of claim 10, wherein the mixture contains substantially equal amounts by volume of surfactant and co surfactant.

12. The method of claim 10, wherein the mixture contains each of the surfactant and the co-surfactant at a concentration of between 0.1 and 5% wt.

13. The method of claim 10, wherein the mixture contains each of the surfactant and the co-surfactant at a concentration of between 1 and 4% wt.

14. The method of claim 1, wherein the surfactant is nonylphenol ethoxylate having between 4 and 80 ethoxylate groups, and wherein the co-surfactant is methanol and/or ethanol.

15. The method of claim 14, wherein the mixture contains substantially equal amounts by volume of surfactant and co-surfactant.

16. The method of claim 14, wherein the mixture contains each of the surfactant and the co-surfactant at a concentration of between 0.1 and 5% wt.

17. The method of claim 14, wherein the mixture contains each of the surfactant and the co-surfactant at a concentration of between 1 and 4% wt.

18. The method of claim 1, further comprising the step of recovering the mixture for use in treating additional pipes.

19. The method of claim 1, further comprising the steps of, after the holding step, flowing hydrocarbons through the pipe while monitoring pressure drop in the pipe until a pre determined pressure drop is reached, and then repeating the transporting and holding steps.

20. The method of claim 1, wherein the preparing step comprises mixing the surfactant and the co-surfactant to form a substantially stable, homogenous mixture, and then mixing the homogenous mixture with the carrier fluid.

21. A pipeline for transporting heavy hydrocarbon, wherein the hydrocarbon is adhered to an inner surface of said pipeline, and wherein a water film is formed over the pipeline inner surface and over the hydrocarbon.

22. The pipeline of claim 21, wherein the water film is adhered over the inner surface and over the hydrocarbon.
